(19) United States
(12) Patent Application Publication
(10) Pub. No.: US 2006/0283019 A1
(43) Pub. Date: Dec. 21, 2006

(54) Slim electric razor

(76) Inventor: Tae-Jun Oh, Namyangju-shi (KR)

Correspondence Address: CANTOR COLBURN, LLP, 55 GRIFFIN ROAD SOUTH, BLOOMFIELD, CT, 06002, US

(21) Appl. No.: 11/454,778

(22) Filed: Jun. 16, 2006

(30) Foreign Application Priority Data
Jun. 21, 2005 (KR) 20-2005-0017857

(51) Int. Cl. B26B 19/00

(52) U.S. Cl. 30/47

(57) ABSTRACT

Disclosed herein is a slim electric razor comprising a body unit containing a drive motor therein, a head unit mounted on the body unit, and a protective cap configured to cover the head unit. The body unit has a pair of upright supporting pieces provided at opposite lateral ends of an upper surface thereof, an eccentric shaft upwardly protruding between the supporting pieces, and a cap fitting base formed at a lower surface thereof. The head unit includes a net support having a coupling recess formed at a rear surface thereof for the coupling of the eccentric shaft and a pair of fitting protrusions formed at opposite lateral surfaces thereof, a blade support, a cutting blade assembly, and a protective net. Guide grooves are formed in opposite lateral surfaces of the body unit and in opposite lateral surfaces of the protective cap such that guide bars having an I-shaped cross section are inserted into the aligned guide grooves of the body unit and protective cap. With the guide bars, the protective cap covers the head unit at ordinary times, but is separated from the head unit and fitted onto the cap fitting base of the body unit, thereby serving as a handle during a shaving operation.

### BACKGROUND OF THE INVENTION

1. Field of the Invention

The present invention relates to a slim electric razor, and more particularly, to a slim electric razor comprising a protective cap, which is usable not only to protect a protective net encasing cutting blades therein, but also as a handle, resulting in an easy shaving operation.

2. Description of the Related Art

Generally, an electric razor is divided into a head unit and a body unit.

The head unit is conventionally provided with a protective net for covering cutting blades.

The protective net is coupled to a cap, which usually covers the protective net, but is separable from the protective net when the razor is used. After completing a shaving operation, the cap is again coupled to the protective net for the sake of safe storage.

However, in the above described conventional structure adopting the detachably attachable cap, there is a risk of loss of the cap when the cap is separated and kept at a separate place. Further, the conventional electric razor suffers from an inconvenience in shaving operation because of a short length of the body unit to be gripped by the user's hand.

### SUMMARY OF THE INVENTION

Therefore, the present invention has been made in view of the above problems, and it is an object of the present invention to provide a slim electric razor comprising a protective cap, which is usable not only to protect a protective net encasing cutting blades therein, but also as a handle, resulting in an easy shaving operation.

In accordance with the present invention, the above and other objects can be accomplished by the provision of a slim electric razor comprising: a body unit containing a drive motor therein and having a pair of upright supporting pieces provided at opposite lateral ends of an upper surface thereof, an eccentric shaft upwardly protruding from the upper surface thereof at an intermediate position between the supporting pieces, and a cap fitting base formed at a lower surface thereof; a head unit mounted on the body unit and including: a net support having a coupling recess formed at a rear surface thereof for the coupling of the eccentric shaft and a pair of fitting protrusions formed at opposite lateral surfaces thereof; a blade support; a cutting blade assembly; and a protective net; and a protective cap configured to cover the head unit, wherein guide grooves are formed in opposite lateral surfaces of the body unit and in opposite lateral surfaces of the protective cap such that guide bars each having an I-shaped cross section are inserted into the aligned guide grooves of the body unit and protective cap to pivotally rotate the protective cap with respect to the body unit, whereby the protective cap covers the head unit at ordinary times, but is separated from the head unit and fitted onto the cap fitting base of the body unit, so as to be used as a handle during a shaving operation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view schematically illustrating the outer configuration of a slim electric razor according to the present invention;

FIG. 2 is a perspective view illustrating a protective cap of the slim electric razor according to the present invention, which is supported by a shaft fitted in a coupling recess formed at a lower end thereof;

FIG. 3 is a detailed view illustrating the inner configuration of the slim electric razor according to the present invention;

FIG. 4 is a side view of the slim electric razor according to the present invention;

FIG. 5 is a sectional view taken along the line A-A of FIG. 4;

FIG. 6 is a concept view illustrating the operation of the slim electric razor according to the present invention;

FIG. 7 is a side view of the slim electric razor according to the present invention, which illustrates a protective cap supported by a shaft fitted in a coupling recess formed at a lower end of the protective cap; and

FIG. 8 is a perspective view of the slim electric razor according to the present invention when viewing from a different direction from that of FIG. 2.

### DESCRIPTION OF THE PREFERRED EMBODIMENTS

Now, a preferred embodiment of the present invention will be explained in detail with reference to the accompanying drawings.

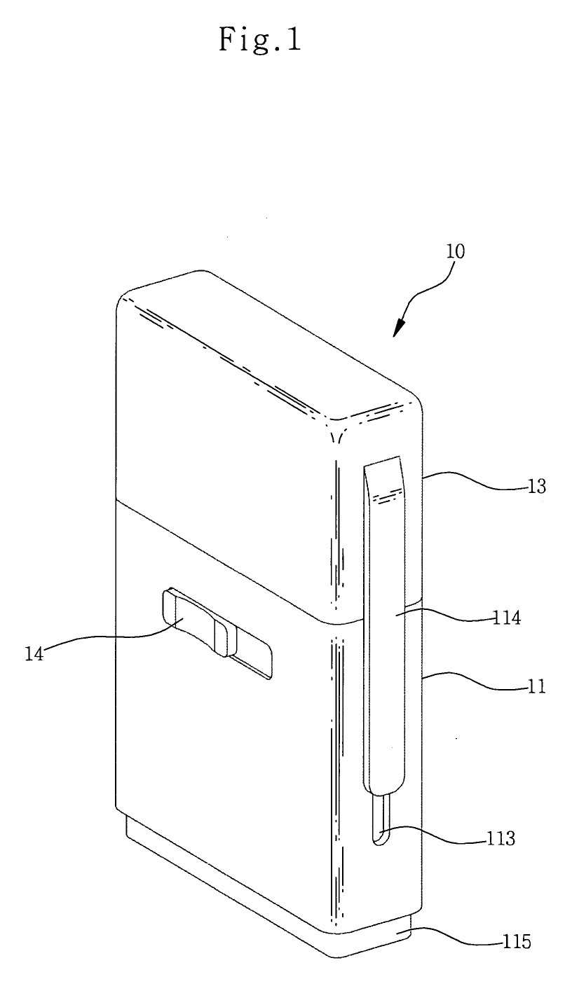

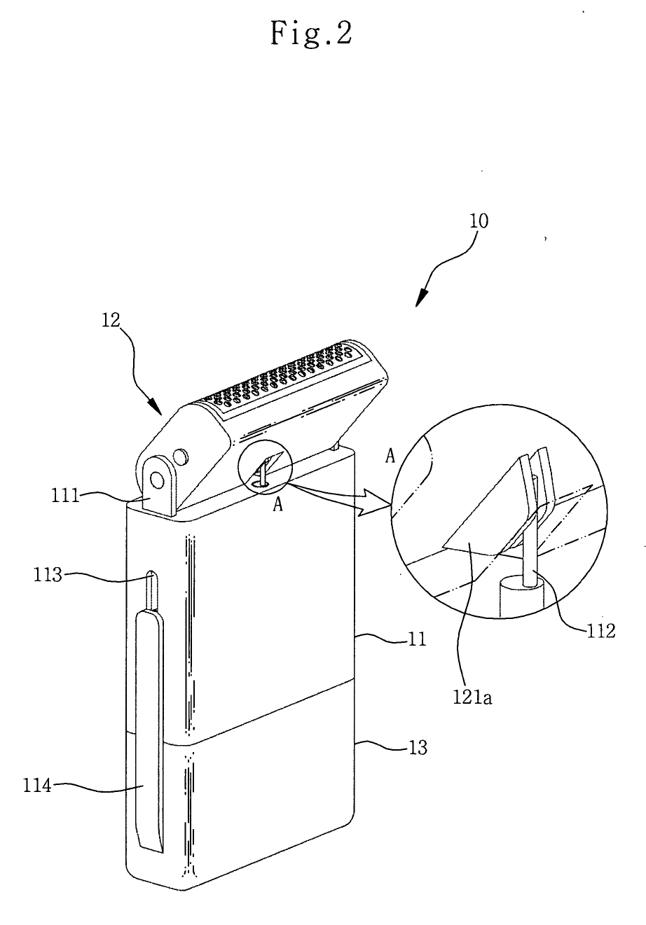

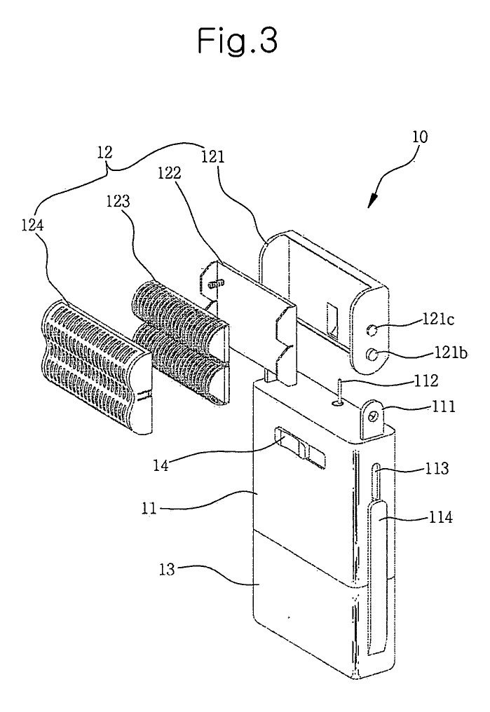

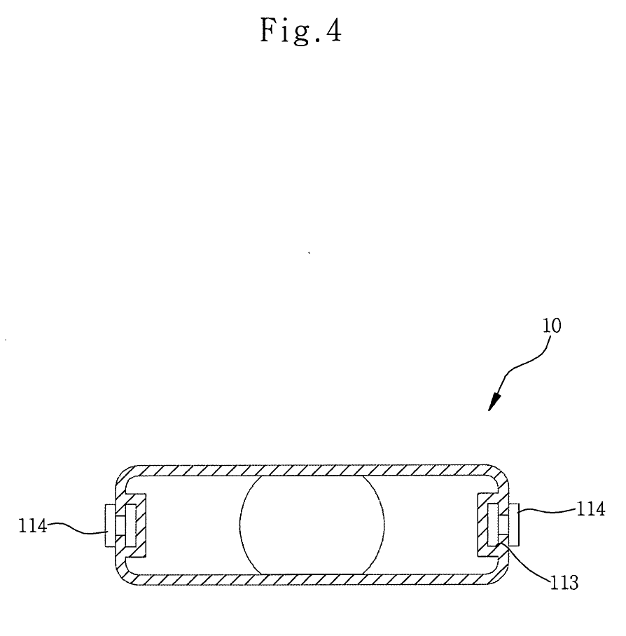

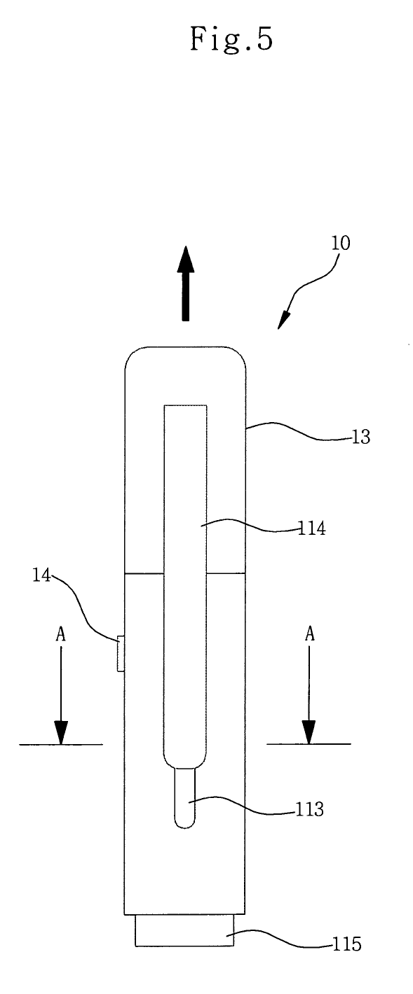

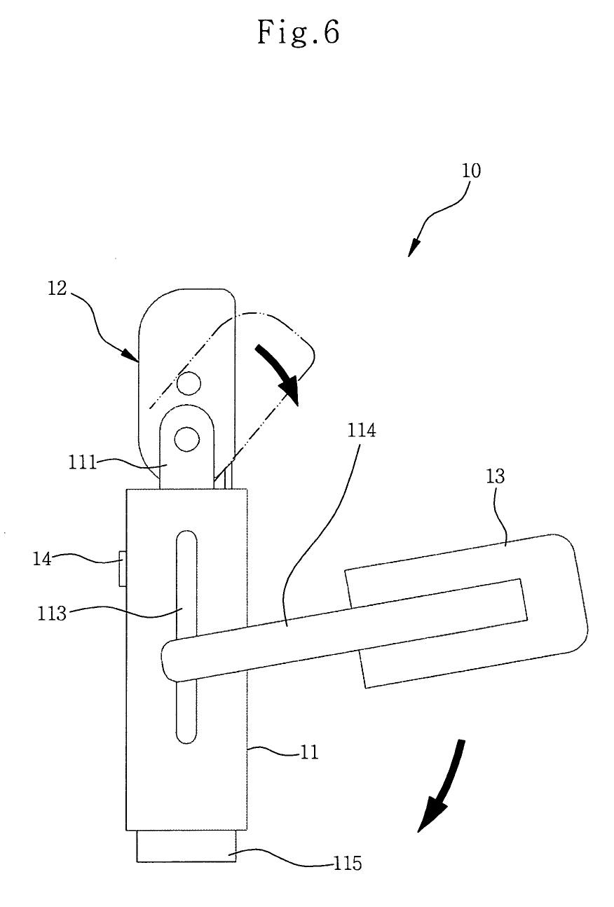

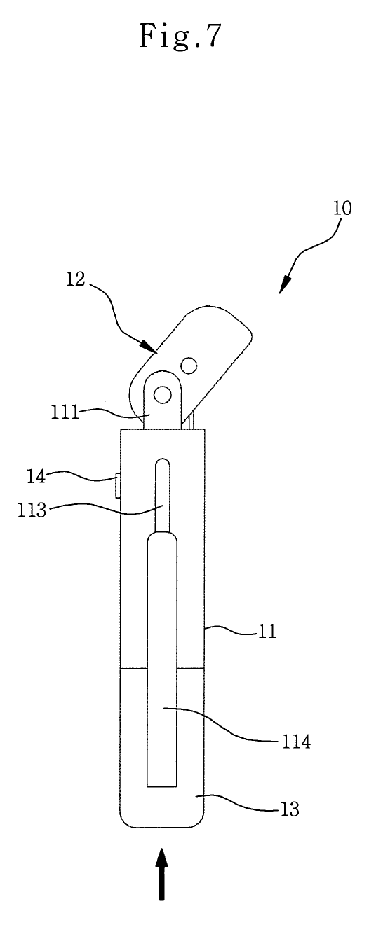

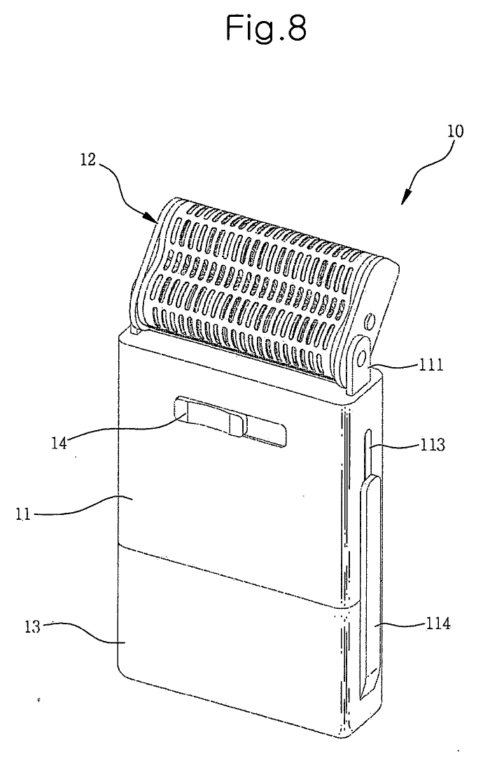

Explaining the accompanying drawings, FIG. 1 is a perspective view schematically illustrating the outer configuration of a slim electric razor according to the present invention, FIG. 2 is a perspective view illustrating a protective cap of the slim electric razor, which is supported by a shaft fitted in a coupling recess at a lower end thereof, FIG. 3 is a detailed view illustrating the inner configuration of the slim electric razor, FIG. 4 is a side view of the slim electric razor, FIG. 5 is a sectional view taken along the line A-A of FIG. 4, FIG. 6 is a concept view illustrating the operation of the slim electric razor, and FIGS. 7 and 8 are a side view and perspective view of the slim electric razor, respectively, which illustrate the protective cap supported by the shaft fitted in the coupling recess of the protective cap.

In the present invention, as stated above, it should be noted that the slim electric razor 10 comprises a protective cap, which is usable not only to protect a protective net encasing a cutting blade therein, but also as a handle, thereby achieving an easy shaving operation.

Specifically, the slim electric razor 10 of the present invention basically comprises a body unit 11 containing a drive motor therein, a head unit 12 mounted on the body unit 11, and a protective cap 13 configured to cover the head unit 12. The body unit 11 has a pair of upright supporting pieces 111 provided at opposite lateral ends of an upper surface thereof, and an eccentric shaft 112 upwardly protruding from an intermediate position of the upper surface between the supporting pieces 111. The head unit 12 includes a net support 121, a blade support 122, a cutting blade assembly 123, and a protective net 124. The net support 121 has a coupling recess 121a formed at a rear surface thereof for the coupling of the eccentric shaft 112 and a pair of fitting protrusions 121b formed at opposite lateral surfaces thereof.

In an outstanding feature of the present invention, guide grooves 113 are formed in opposite lateral surfaces of the body unit 11 and in opposite lateral surfaces of the protective cap 13 such that guide bars 114 having an I-shaped cross section are inserted into the aligned guide grooves 113 of the body unit 11 and protective cap 13. With the use of the guide bars 114, the protective cap 13, which covers the head unit 12 at ordinary times, is separable from the head unit 12 to prepare a shaving operation. Once being separated from the head unit 12, the protective cap is fitted onto a cap fitting base 115 formed at a lower surface of the body unit 11, thereby serving as a handle during a shaving operation.

That is, in the present invention having the above described configuration, the protective cap covers the head unit at ordinary times, but is separated from the head unit and fitted onto the cap fitting base formed at the lower surface of the body unit. Thereby, the protective cap is usable as a handle during a shaving operation, and therefore, the electric razor having the protective cap has an advantage of reducing an inconvenience in use.

Although not shown in the drawings, each guide bar 114 has a circular protrusion formed at a lower end of an inner surface thereof inserted in the guide groove 113. As the guide bar 114 is pivotally rotated about the circular protrusion, the protective cap 13 is able to be pivotally rotated and fitted onto the cap fitting base 115 of the body unit 11.

As apparent from the above description, in the slim electric razor according to the present invention, the protective cap is used to cover the head unit at ordinary times, but is separated from the head unit and fitted onto the cap fitting base formed at the lower surface of the body unit, whereby the protective cap can be used as a handle during a shaving operation, resulting in an easy and convenient shaving operation.

Although the slim electric razor according to the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A slim electric razor comprising:
a body unit containing a drive motor therein and having a pair of upright supporting pieces provided at opposite lateral ends of an upper surface thereof, an eccentric shaft upwardly protruding from the upper surface thereof at an intermediate position between the supporting pieces, and a cap fitting base formed at a lower surface thereof;
a head unit mounted on the body unit and including: a net support having a coupling recess formed at a rear surface thereof for the coupling of the eccentric shaft and a pair of fitting protrusions formed at opposite lateral surfaces thereof; a blade support; a cutting blade assembly; and a protective net; and
a protective cap configured to cover the head unit,
wherein guide grooves are formed in opposite lateral surfaces of the body unit and in opposite lateral surfaces of the protective cap such that guide bars each having an I-shaped cross section are inserted into the aligned guide grooves of the body unit and protective cap to pivotally rotate the protective cap with respect to the body unit,
whereby the protective cap covers the head unit at ordinary times, but is separated from the head unit and fitted onto the cap fitting base of the body unit, so as to be used as a handle during a shaving operation.
